(19) United States
(12) Patent Application Publication
(10) Pub. No.: US 2006/0179697 A1
(43) Pub. Date: Aug. 17, 2006

(54) Drive-Thru-Communication Center

(76) Inventors: Shelley D. Greenwald, Sarasota, FL (US); Larry Greenwald, Sarasota, FL (US)

Correspondence Address: Shelley D. Greenwald, 5045 Robinsong Rd., Sarasota, FL, 34233, US

(21) Appl. No.: 11/056,461

(22) Filed: Feb. 11, 2005

(51) Int. Cl. G09F 7/08

(52) U.S. Cl. 40/611.01

(57) ABSTRACT

The DrivThru Communication Center is a single flat opaque sign/message holder designed specifically for drive-through window service businesses. The width, height, length are determined by the size of the window opening. Clear acrylic sign/message holders are built into the display at intervals so that messages, relating to the business, can be displayed to their customers. On the opposite side (inside facing the business) of the acrylic are another set of messages aimed at motivating employees and showcasing business products as a reminder to employees of sales avenues. Its other purpose, besides communication, is to hide the possible clutter on counters inside the window. Previously there has been no single display designed to serve these purposes other than painted lines or vinyl stretched across the bottom of the window with sign/messages taped to the window.

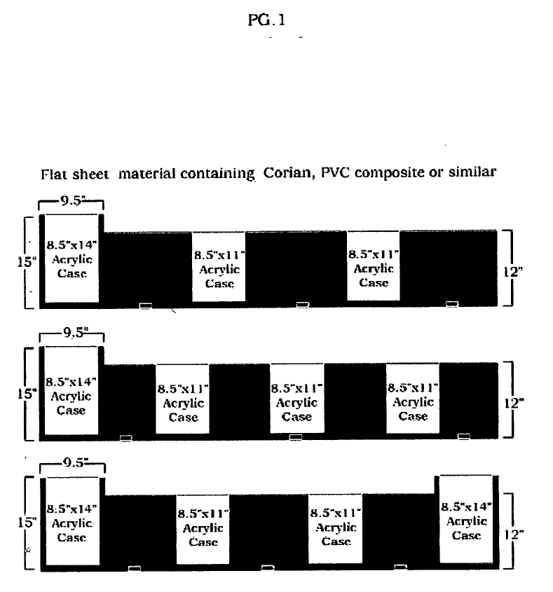

### DETAILED DESCRIPTION

Using readily available opaque flat sheet materials containing solid surface, composite or PVC purchased from a variety of wholesale providers and custom shaped clear acrylic message holders the Drive-ThruCommunication Center is fashioned.

The thickness of ½″, ¾″ +/−, with a length custom cut to fit the window opening, and a height designed to obscure the material and area behind the window, the invention is a simple utility design with ⅜″ dear acrylic messages holders placed into predetermined cut openings. Using table saws, Jigsaws and routers, openings, either horizontal or vertical, are cut Into the flat sheet material. Folded at the bottom only and open at the sides and top clear acrylic holders, ⅜″ thick, are glued into the openings to hold printed messages.

The acrylic holders are manufactured to open at the top so material can be removed and replaced easily.

The invention is used for three purposes 1) To hide messy and disorganized drive through bank teller/pharmacy/fast food restaurant windows, using the above invention, from the drive through customer, 2) By using clear acrylic see through sign holders the business can communicate to their clients marketing, sale and promotional items and 3) from the inside the business employees will see motivational messages along with items the business wants to sell/promote

What distinguishes this invention from what is currently being used is the combination sign/message holder and visual barrier custom colored to the clients needs. Currently most drive throughs do nothing or paint a stripe or stretch a plain banner across the window bottom. There is no marketing area, signs are still taped to the windows and there is no cohesive message being sent to the customer from the business.

If you notice, in the attached drawing, the simplicity of the Invention allows each client to change signs, messages simply by removing the old & Inserting the new In the dear acrylic areas.

1. We claim our invention, The Drive-Thru-Communication Center, containing flat sheet composite, opaque solid surface material, or similar matter, ½″-1″+/− thickness with numerous (depending on the need) clear acrylic “window” message holder's, at a length and height determined by the window (s) opening (s). The acrylic holders are folded clear acrylic so that paper messages can be slid in and out easily. This is a single unit, per window, custom colored to the business needs.
